(19) United States
(12) Patent Application Publication
(10) Pub. No.: US 2018/0248237 A1
(43) Pub. Date: Aug. 30, 2018

(54) BATTERY PACK

(71) Applicant: Robert Bosch GmbH, Stuttgart (DE)

(72) Inventors: Florian Postler, Schesslitz (DE); Timo Kegel, Memmelsdorf (DE); Alexander Klonczynski, Bangalore (IN); Gerhard Schubert, Strullendorf (DE); Johannes Teuber, Anderson, SC (US); Sabine Stadter, Bamberg (DE)

(21) Appl. No.: 15/752,750

(22) PCT Filed: Aug. 3, 2016
(86) PCT No.: PCT/EP2016/068485

§ 371 Date: Feb. 14, 2018

(30) Foreign Application Priority Data
Aug. 21, 2015 (DE) 10 2015 216 029.7

(51) Int. Cl. H01M 10/613; H01M 10/625; H01M 10/6554; H01M 2/10; H01M 10/6556; H01M 10/6567; H01M 10/6551; B60L 11/18

(52) U.S. Cl. CPC H01M 10/613; H01M 10/625; H01M 10/6554; H01M 2/1083; Y10S 903/907; H01M 10/6567; H01M 10/6551; B60L 11/1874; H01M 2220/20; H01M 10/6556

(57) ABSTRACT

The invention relates to a battery pack (50) comprising a housing (72) in which at least one battery module (60) having at least one battery cell (2) is arranged, as well as a cooling system for cooling said at least one battery cell (2). The cooling system at least comprises a cooling plate (62) arranged outside the housing (72), said at least one cooling plate (62) lying flat against a cover plate (80) of the housing (72) and heat dissipating from the at least one battery cell (2) to the cooling plate (62) through said cover plate (80).

### BACKGROUND OF THE INVENTION

The invention relates to a battery pack which comprises a housing in which at least one battery module having at least one battery cell is arranged, as well as a cooling system for cooling said at least one battery cell.

Electric energy can be stored by means of batteries. Batteries convert chemical reaction energy into electric energy. Primary batteries and secondary batteries are differentiated here. Primary batteries are only functional once, whereas secondary batteries, which are also referred to as accumulators, can be recharged. A battery thereby comprises one or a plurality of battery cells.

Particularly so-called lithium-ion battery cells are used in an accumulator. These are characterized inter alia by high energy densities, thermal stability and an extremely low self-discharge. Lithium-ion batteries are used inter alia in motor vehicles, particularly in electric vehicles (EV), hybrid vehicles (hybrid electric vehicle, HEV) as well as in plug-in hybrid vehicles (plug-in hybrid electric vehicle, PHEV).

A generic battery cell is disclosed in the German patent application DE 10 2012 217 451 A1. The battery cell has a cell housing which is, for example, made from a metal. The cell housing is configured prismatic, in particular cuboid, and is of pressure-resistant design. The battery cell has a positive terminal and a negative terminal for electrical contacting.

A plurality of battery cells is consolidated to form a battery module and are electrically connected to one another. To this end, the terminals of the battery cells are connected to one another by means of cell connectors. A plurality of battery modules is consolidated to form a battery pack and is arranged in a common housing.

The individual battery cells heat up during operation. Therefore, the battery packs or battery modules generally comprise a cooling system for cooling the battery cells.

A battery system having a housing is known from the German patent application DE 10 2013 210 932 A1, in which housing a plurality of battery cells is arranged. The housing thus has a wall in which cooling channels are provided, through which a cooling agent flows.

The German patent application DE 10 2013 204 087 A1 discloses a battery module which is arranged in a gas-tight housing. A cooling device, which is thermally connected to the battery cells, is provided within the housing.

The German patent application DE 21 2012 000 235 U1 relates to a battery pack having a plurality of battery cells, said battery pack being arranged in a housing having air cooling. Cooling air passages designed as channels are provided in the housing.

A battery system is disclosed in the German patent application DE 10 2013 213 877 A1, which comprises a plurality of battery cells that are arranged in a common housing. In order to cool the battery cells, the housing has air inlets and air outlets, via which cool air is supplied to the battery cells and heated air is discharged.

### SUMMARY OF THE INVENTION

A battery pack is proposed which comprises a housing in which at least one battery module having at least one battery cell is arranged, as well as a cooling system for cooling the at least one battery cell. The housing of the battery pack is made, for example, from metal, in particular from aluminum.

According to the invention, the cooling system comprises at least one cooling plate arranged outside of the housing of the battery pack. Said at least one cooling plate lies flat against a cover plate of the housing, and heat dissipates from the at least one battery cell to the cooling plate through said cover plate. The housing of the battery pack, in particular the cover plate, thereby has a relatively high thermal conductivity.

According to an advantageous embodiment of the invention, the housing is designed in a gas-tight manner. In the case of a battery pack that is used in a vehicle, this prevents released gas from entering the passenger compartment in the event of a degassing of a battery cell.

The housing advantageously has an outlet opening for released gas. Said outlet opening is thereby closed during normal operation of the battery pack, and the housing is gas-tight. If, in the event of a fault, gas is released from the battery cells and excess pressure develops within the housing, the outlet opening opens and lets the released gas escape in order to prevent too high of a pressure from developing within the housing, which could lead to an explosion. The outlet opening is disposed in such a way that escaping gas cannot penetrate into the passenger compartment.

The housing preferably comprises two side walls running parallel to one another and two front walls running parallel to one another, which are connected to one another. The side walls are thereby disposed at right angles to the front walls. The side walls and the front walls together form a frame. Said frame is designed in this case rigidly and in a torsion-proof manner and protects the battery cells of the battery pack even in the event of a crash.

The at least one battery module is preferably fixed to the frame. The battery cells of the at least one battery module are therefore also protected even in the event of a crash by the frame which is designed rigidly and in a torsion-proof manner.

The housing also preferably comprises two cover plates which run parallel to one another and close the frame on both sides. The cover plates are thus disposed at right angles to the side walls and at right angles to the front walls. The housing is thus designed at least approximately cuboid.

According to an advantageous modification to the invention, the cooling system comprises at least one flow channel, which is provided in at least one side wall and/or in at least one front wall of the frame. An additional cooling of the battery cells can thus take place via the side walls as well as via the front walls of the frame.

The frame advantageously comprises a dividing wall which runs parallel to the side walls. Said dividing wall is fixedly connected to the front walls and additionally stabilizes and stiffens the frame of the housing.

In a particularly advantageous manner, the cooling system comprises at least one flow channel which is provided in the dividing wall of the frame. An additional cooling of the battery cells can thus take place via the dividing wall of the frame.

The cooling system preferably comprises a liquid cooling medium.

A battery pack according to the invention is advantageously used in an electric vehicle (EV), in a hybrid vehicle (HEV), in a plug-in hybrid vehicle, in a stationary battery or in a battery in a marine application.

By means of the inventive design of the battery pack, a line of the cooling system does not have to be guided into the gas-tight housing. As a result, the cooling system does not have to be separately sealed off from the battery cells and the number of interfaces of the battery pack is reduced. The connection of the battery pack to a customer specific cooling system, which is particularly present in a motor vehicle, is also easily possible. The volume of the battery pack is also reduced and the required installation space is thus reduced.

The number of critically leakproof points of the cooling system is also reduced, whereby tightness tests of the cooling system can be omitted during production of the battery pack. In the event of a possible leak in the cooling system, it is furthermore ruled out that coolant comes into contact with the battery cells.

### BRIEF DESCRIPTION OF THE DRAWINGS

Embodiments of the invention are explained in greater detail with the aid of the drawings and the following description. In the drawings:

FIG. 1 shows a perspective depiction of a housing of a battery pack, wherein a cover plate is removed;

FIG. 2 shows a perspective depiction of a battery pack, wherein a front wall and a cover plate of the housing are removed;

FIG. 3 shows an enlarged depiction of a partial region from FIG. 2;

FIG. 4 shows a perspective depiction of a battery pack, wherein a cover plate of the housing is removed; and

FIG. 5 shows as perspective depiction of a complete battery pack.

### DETAILED DESCRIPTION

In the following description of the embodiments of the invention, identical or similar elements are denoted with the same reference signs, wherein a repeated description of these elements is omitted in individual cases. The figures only schematically depict the subject matter of the invention.

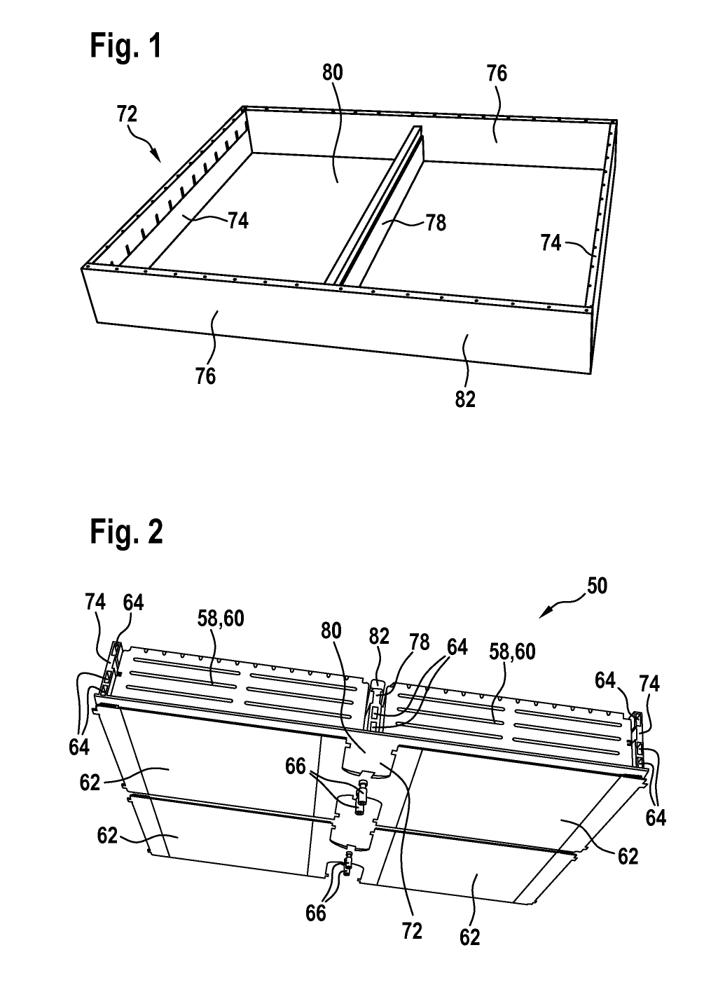

FIG. 1 shows a perspective depiction of a housing 72 of a battery pack 50. The housing 72 has a frame 82 as well as two cover plates 80. One of the cover plates 80 is removed in the present depiction.

The frame 82 comprises two side walls 74 which run parallel to one another as well as two front walls 76 which run parallel to one another. Furthermore, the frame 82 comprises a dividing wall 78 which runs parallel to the two side walls 74 and between the same.

The front walls 76 are disposed at right angles to the side walls 74 as well as to the dividing wall 78. The dividing wall 78 is connected to the two front walls 76. The side walls 74 are likewise connected to the two front walls 76. The frame 82 formed from the side walls 74, the front walls 76 and the dividing wall 78 is designed particularly rigidly and in a torsion-proof manner.

The frame 82 formed in this way has two openings which are later closed by the cover plates 80. The cover plates 80 run parallel to one another as well as at right angles to the side walls 74, the front walls 76 and the dividing wall 78. The housing 772 of the battery pack 50 which is formed by the frame 82 and the cover plates 80 is thus designed approximately cuboid.

FIG. 2 shows a perspective depiction of the battery pack 50. In the depiction shown, a front wall 76 and also a cover plate 80 of the housing 72 are removed.

A plurality of battery modules 60 is arranged in the housing 72 of the battery pack 50. Each of the battery modules 60 comprises a plurality of battery cells 2, which are not visible in this depiction, as well as clamping plates 58 which are disposed laterally of the battery cells 2. In the depiction shown, the clamping plates 58 conceal the battery cells 2.

The battery modules 60 are fixed to the frame 82. In the present embodiment, the battery modules 60 are secured to the side walls 74 as well as to the dividing wall 78. A plurality of cooling plates 62 is arranged outside of the housing 72, which are part of a cooling system. The cooling plates 62 lie flat on a cover plate 80 of the housing 72.

The housing 72 of the battery pack 50 is made from a metal, in the present example from aluminum. The cover plates are particularly made from a metal, in this case from aluminum, and thus have a relatively high thermal conductivity.

The cooling plates 62 comprise coolant connections 66 which are used to feed as well as discharge a coolant. In the present embodiment, this relates to a liquid coolant. It is, however, also conceivable that the coolant is present in a gaseous state. In the depiction shown, each two cooling plates 62 share two coolant connections 66.

If the battery cells 2 are heated up in the interior of the housing 72, heat is dissipated to the cooling plates 62 through the cover plate 80 of the housing 72. The heat absorbed from the coolant is then transported away from the cooling plates 62 through one of the coolant connections 66.

Additional flow channels 64 are furthermore provided in the side walls 74 as well as in the dividing wall 78 of the frame 82. Said flow channels 64 are likewise part of the cooling system of the battery pack 50. It is furthermore conceivable that flow channels 64 are likewise provided in the front walls 76 of the frame 82.

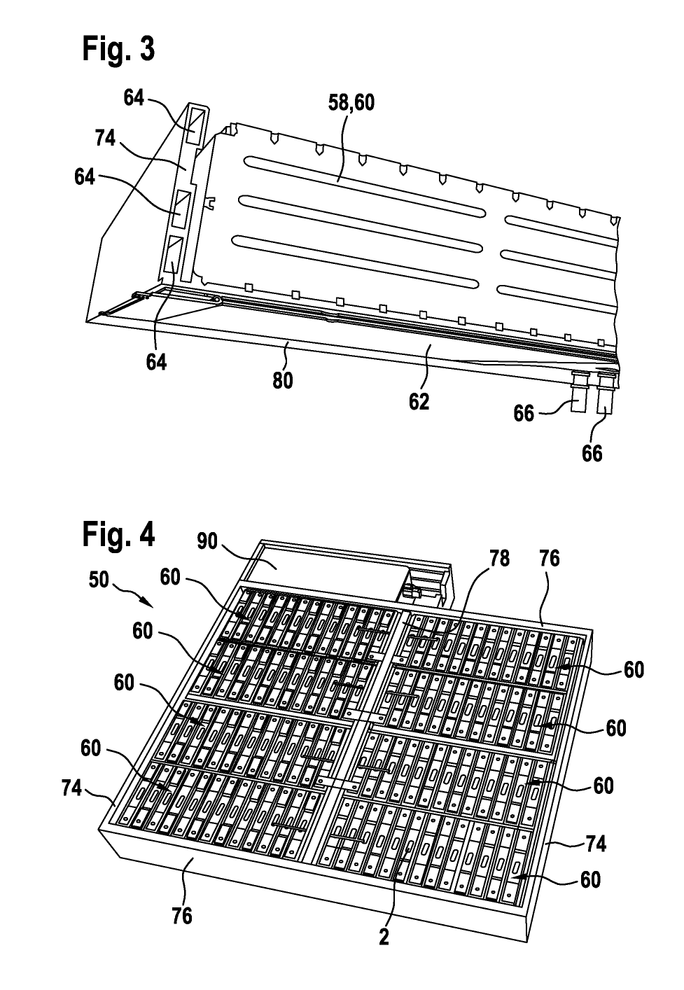

FIG. 3 shows an enlarged depiction of a partial region from FIG. 2. In so doing, one of the two side walls 74 is particularly magnified. The side wall 74 depicted here comprises a plurality, here three, of flow channels 64.

A coolant flows through said flow channels 64. If the battery cells 2 are heated up, heat additionally dissipates through the side wall 74 of the frame 82 to the coolant which flows through the flow channels 64. An additional cooling also takes place via the dividing wall 78, which is not shown here and which likewise has flow channels 64 through which the coolant flows.

FIG. 4 shows a further perspective depiction of the battery pack 50 from another perspective. In the depiction shown, a cover plate 80 of the housing 72 is removed.

The battery pack 50 thereby comprises a plurality, in the present case eight, of battery modules 60. Each of the battery modules 60 comprises a plurality of battery cells 2. In the present embodiment, the battery modules 60 are similarly designed and comprise in each case thirteen battery cells 2. The battery cells 2 are arranged side by side and are surrounded on both sides by clamping plates 58 which are not shown here.

The battery modules 60 are presently arranged in two groups, each group comprising four battery modules 60. In so doing, a group having four battery modules 60 is arranged in each case on each side of the dividing wall. A control module 90 for controlling and monitoring the battery pack 50 is additionally provided outside of the housing 72.

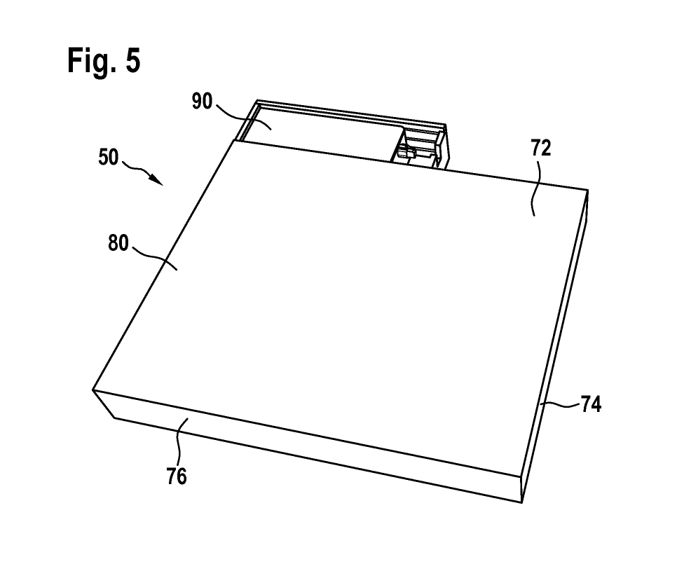

FIG. 5 shows a perspective depiction of a complete battery pack 50. In the depiction shown here, the cover plate 80 is visible, which conceals the battery modules 60 having the battery cells 2, as well as the dividing wall 78.

The housing 72 of the battery pack 50 is designed in a gas-tight manner. If gas escapes from a battery cell 2, said gas remains within the housing 72. The housing 72 additionally comprises an outlet opening, which is not shown here. If, in the event of a fault, gas is released from a battery cell 2 and consequently excess pressure develops within the housing 72, said outlet opening then opens and allows the released gas to escape in a controlled manner. As a result, excess pressure within the housing 72 is prevented, which otherwise could cause the housing 72 to explode.

The invention is not limited to the exemplary embodiments described here and the aspects emphasized therein. Instead a multiplicity of modifications, which lie within the scope of action of a person skilled in the art, is, in fact, possible within the range specified by the claims.

1. A battery pack (50) comprising
a housing (72) in which at least one battery module (60) having at least one battery cell (2) is arranged, and
a cooling system for cooling the at least one battery cell (2),
wherein the cooling system comprises at least one cooling plate (62) arranged outside of the housing (72), said at least one cooling plate (62) lying flat against a cover plate (80) of the housing (72) such that heat dissipates from the at least one battery cell (2) to the cooling plate (62) through said cover plate (80).

2. The battery pack (50) according to claim 1, characterized in that the housing (72) is gas-tight.

3. The battery pack (50) according to claim 1, characterized in that the housing (72) comprises two side walls (74) that run parallel to one another and two front walls (76) that run parallel to one another, wherein the side walls and the front walls are connected to one another and form a frame (82).

4. The battery pack (50) according to claim 3, characterized in that the at least one battery module (60) is fixed to the frame (82).

5. The battery pack (50) according to claim 3, characterized in that the housing (72) comprises two cover plates (80) which run parallel to one another and close the frame (82) on both sides.

6. The battery pack (50) according to claim 3, characterized in that the cooling system comprises at least one flow channel (64) which is provided in at least one side wall (74) and/or in at least one front wall (76) of the frame (82).

7. The battery pack (50) according to claim 3, characterized in that the frame (82) comprises a dividing wall (78) which runs parallel to the side walls (74).

8. The battery pack (50) according to claim 7, characterized in that the cooling system comprises at least one flow channel (64) in the dividing wall (78).

9. The battery pack (50) according to claim 1, characterized in that the cooling system comprises a liquid cooling medium.

10. (canceled)

11. A vehicle comprising a battery pack according to claim 1.

12. The vehicle according to claim 11 wherein the vehicle is an electric vehicle (EV).

13. The vehicle according to claim 11 wherein the vehicle is a hybrid vehicle (HEV).

14. The vehicle according to claim 11 wherein the vehicle is a plug-in hybrid vehicle (PHEV).
